(19) United States
(12) Patent Application Publication
(10) Pub. No.: US 2025/0078466 A1
(43) Pub. Date: Mar. 6, 2025

(54) MODE-SELECTABLE COMPUTER VISION USING IMAGE CLASSIFIER MODEL

(71) Applicant: THE BOEING COMPANY, Arlington, VA (US)

(72) Inventors: Esteban F. LOPEZ, Bridgeton, MO (US); Liessman E. STURLAUGSON, St. Louis, MO (US); Peter G. RHODES, Bridgeton, MO (US)

(21) Appl. No.: 18/825,757

(22) Filed: Sep. 5, 2024

Related U.S. Application Data
(60) Provisional application No. 63/580,588, filed on Sep. 5, 2023.

(51) Int. Cl. G06V 10/764; G06T 7/11; G06V 20/70

(52) U.S. Cl. CPC G06V 10/764; G06T 7/11; G06V 20/70

(57) ABSTRACT

The present disclosure provides a method including defining a search space within a first image, which includes defining a plurality of image regions, generating second images corresponding to the image regions (for an image region, the corresponding second image substitutes reference pixels for the portion of the first image outside the image region), and applying an image classification model (trained to disregard the reference pixels) to the plurality of second images. The method further includes performing object detection on the search space using the image classification model.

### CROSS-REFERENCE TO RELATED APPLICATIONS

This application claims benefit of U.S. provisional patent application Ser. No. 63/580,588, filed Sep. 5, 2023, which is incorporated herein by reference in its entirety. This application is further related to U.S. patent application Ser. No. 17/814,109 (filed Jul. 21, 2022) and Ser. No. 18/798,504 (filed Aug. 8, 2024), which are incorporated herein by reference in their entirety.

### FIELD

Aspects of the present disclosure relate to computer vision, and more specifically, techniques for mode-selectable computer vision (e.g., image classification, object detection, or image segmentation) on an image using an image classifier model.

### BACKGROUND

Object detection is a fundamental function in computer vision that involves identifying and locating objects depicted in an image or a video sequence. Object detection models are typically provided with a portion of an image (sometimes termed as a “crop” or a “cell”), and the object detection models perform image classification and object localization functions on the portion. A typical output of object detection models includes one or more bounding boxes around the detected object(s), as well as class labels describing the detected object(s). Object detection is used in various applications, such as autonomous vehicles, security services, image recognition, and augmented reality.

Image segmentation is another computer vision function that involves dividing an image into multiple segments (e.g., groups of pixels) to simplify or change the representation of the image into something more meaningful and easier to analyze. Some example types of image segmentation include semantic segmentation (where each pixel of the image is assigned a particular class label) and instance segmentation (where different instances of the same class are segmented separately).

### SUMMARY

The present disclosure provides a method in one aspect, the method including defining a search space within a first image, which includes: defining a plurality of image regions that encompasses an entirety of the first image; generating, based on the first image, a plurality of second images corresponding to the plurality of image regions, wherein for an image region of the plurality of image regions, the corresponding second image substitutes reference pixels for the portion of the first image outside the image region; and applying an image classification model to the plurality of second images to determine whether an object is identified within the plurality of image regions, wherein the image classification model is trained to disregard the reference pixels. The method further includes performing object detection on the search space using the image classification model.

In one aspect, in combination with any example method above or below, performing object detection on the search space includes: sweeping a first window through a plurality of first positions that encompasses an entirety of the search space; generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and applying the image classification model to the plurality of third images to determine a first area of the object referenced to the plurality of first positions.

In one aspect, in combination with any example method above or below, the method further includes performing image segmentation on the search space, wherein performing image segmentation includes at least one iteration of: sweeping a second window through a plurality of second positions that encompasses an entirety of the search space, the second window different than the first window; generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space; applying the image classification model to the plurality of fourth images to determine a second area of the object referenced to the plurality of second positions; and combining the second area with the first area.

In one aspect, in combination with any example method above or below, combining the second area with the first area includes performing one of: an intersection function; a union function; and a voting function.

In one aspect, in combination with any example method above or below, defining a plurality of image regions includes: defining a plurality of first image regions, along a first dimension, that encompasses at least a portion of the first image; and defining a plurality of second image regions, along a second dimension, that encompasses at least a portion of the first image.

In one aspect, in combination with any example method above or below, the first image includes a whole-image label identifying the object.

In one aspect, in combination with any example method above or below, the method further includes receiving an input that indicates whether to perform image classification, object detection, or image segmentation on the first image; and determining, based on the input, a proportion of the reference pixels to be used for generating the plurality of second images.

The present disclosure provides a computer program product in one aspect, the computer program product including: a computer-readable storage medium having computer-readable program code embodied therewith, the computer-readable program code executable by one or more computer processors to perform an operation including defining a search space within a first image, which includes: defining a plurality of image regions that encompasses an entirety of the first image; generating, based on the first image, a plurality of second images corresponding to the plurality of image regions, wherein for an image region of the plurality of image regions, the corresponding second image substitutes reference pixels for the portion of the first image outside the image region; and applying an image classification model to the plurality of second images to determine whether an object is identified within the plurality of image regions, wherein the image classification model is trained to disregard the reference pixels. The operation further includes performing object detection on the search space using the image classification model.

In one aspect, in combination with any example computer program product above or below, performing object detection on the search space includes: sweeping a first window through a plurality of first positions that encompasses an entirety of the search space; generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and applying the image classification model to the plurality of third images to determine a first area of the object referenced to the plurality of first positions.

In one aspect, in combination with any example computer program product above or below, the operation further includes: performing image segmentation on the search space, wherein performing image segmentation includes at least one iteration of: sweeping a second window through a plurality of second positions that encompasses an entirety of the search space, the second window different than the first window; generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space; applying the image classification model to the plurality of fourth images to determine a second area of the object referenced to the plurality of second positions; and combining the second area with the first area.

In one aspect, in combination with any example computer program product above or below, combining the second area with the first area includes performing one of: an intersection function; a union function; and a voting function.

In one aspect, in combination with any example computer program product above or below, defining a plurality of image regions includes: defining a plurality of first image regions, along a first dimension, that encompasses at least a portion of the first image; and defining a plurality of second image regions, along a second dimension, that encompasses at least a portion of the first image.

In one aspect, in combination with any example computer program product above or below, the first image includes a whole-image label identifying the object.

In one aspect, in combination with any example computer program product above or below, the operation further includes: receiving an input that indicates whether to perform image classification, object detection, or image segmentation on the first image; and determining, based on the input, a proportion of the reference pixels to be used for generating the plurality of second images.

The present disclosure provides a system in one aspect, the system including a memory storing an image classification model that is trained to disregard reference pixels; and one or more processors configured to perform an operation including: defining a search space within a first image, which includes: defining a plurality of image regions that encompasses an entirety of the first image; generating, based on the first image, a plurality of second images corresponding to the plurality of image regions, wherein for an image region of the plurality of image regions, the corresponding second image substitutes the reference pixels for the portion of the first image outside the image region; and applying an image classification model to the plurality of second images to determine whether an object is identified within the plurality of image regions. The operation further includes performing object detection on the search space using the image classification model.

In one aspect, in combination with any example system above or below, performing object detection on the search space includes: sweeping a first window through a plurality of first positions that encompasses an entirety of the search space; generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and applying the image classification model to the plurality of third images to determine a first area of the object referenced to the plurality of first positions.

In one aspect, in combination with any example system above or below, the operation further includes performing image segmentation on the search space, wherein performing image segmentation includes at least one iteration of: sweeping a second window through a plurality of second positions that encompasses an entirety of the search space, the second window different than the first window; generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space; applying the image classification model to the plurality of fourth images to determine a second area of the object referenced to the plurality of second positions; and combining the second area with the first area.

In one aspect, in combination with any example system above or below, combining the second area with the first area includes performing one of: an intersection function; a union function; and a voting function.

In one aspect, in combination with any example system above or below, defining a plurality of image regions includes: defining a plurality of first image regions, along a first dimension, that encompasses at least a portion of the first image; and defining a plurality of second image regions, along a second dimension, that encompasses at least a portion of the first image.

In one aspect, in combination with any example system above or below, the first image includes a whole-image label identifying the object.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example system for mode-selectable computer vision using an image classification model, according to one or more aspects.

FIGS. 2A-2C is an example method of mode-selectable computer vision using an image classification model, according to one or more aspects.

FIGS. 3A-3E depict an example sequence of defining image regions along multiple dimensions, according to one or more aspects.

FIG. 4A depicts defining a search space within an image, according to one or more aspects.

FIG. 4B depicts an example sequence of sweeping a window through a search space, according to one or more aspects.

FIGS. 5A-5C depicts an example sequence of performing image segmentation on a search space, according to one or more aspects.

FIG. 6 depicts a border defined around an object using exemplary object detection techniques, according to one or more aspects.

### DETAILED DESCRIPTION

Computer vision using deep learning continues to increase in popularity, as numerous applications leverage the ability to classify and find objects depicted in images. Deep learning approaches are often categorized into one of three approaches: image classification, object detection, or image segmentation. Using conventional techniques, switching between the different approaches requires significant changes to the model architecture, limits the reusability of code, and requires model retraining. Thus, switching between different approaches is a time and resource-intensive process without any assurances that the new model will perform as desired.

Another challenge in switching between computer vision approaches is that each approach typically requires a different level of label fidelity. For example, labels in image classification are applied to the whole image, labels in object detection are associated with bounding boxes defined around objects, and labels in image segmentation are applied to each pixel. Conventional image segmentation solutions also require a more complex architecture, typically employing an image segmentation model followed by a segment classification model. The process of updating labels to meet increasing fidelity requirements is time and resource-intensive.

According to various aspects described herein, all three approaches may be approximated using a single model architecture, with potentially no requirement for model retraining. In some aspects, portions of an image are substituted with reference pixels (e.g., a predefined masking color or pattern) and an image classification model is applied to the substituted image to determine whether the non-masked portion depicts the object. In some aspects, a user can select between image classification, object detection, and image segmentation operations by altering one or more parameters that determine a proportion and/or a location of the reference pixels within the image.

In some aspects, the model architecture receives a whole-image label identifying the object depicted therein. The model architecture may use more detailed labels for the images when available. In some aspects, the model architecture uses an image classifier model that has been trained to disregard the reference pixels (e.g., to identify portions with the reference pixels as non-relevant). Switching between approaches can be achieved by varying a proportion of the image that is substituted with reference pixels (e.g., none for image classification, a greater proportion for object detection, and an even greater proportion for image segmentation).

In some aspects, the model architecture may be applied standalone to images. In other aspects, the model architecture may be used in conjunction with other computer vision techniques. In one example, an image segmentation process is first performed on the image, but the confidence value for a generated border is less than a threshold value. This may be the case where multiple objects of interest are depicted in close proximity, as the interstitial spaces may be incorrectly labeled as including an object. The model architecture may be suitable to better define the objects and thereby avoid the incorrect labeling. In another example, the model architecture is used within an object detection process, such that “crops” or “cells” generated from the image are input to the model architecture for processing.

The image classification model of the model architecture is capable of specific identification of object(s) depicted in the image. In some aspects, the model architecture uses an image segmentation model that itself is not capable of such specific identification, e.g., an image segmentation model that specializes in segmenting between a foreground and a background of the image. Thus, the model architecture can incorporate both the image classification model and the image segmentation model without requiring that a separate image segmentation model (capable of the identification) be trained.

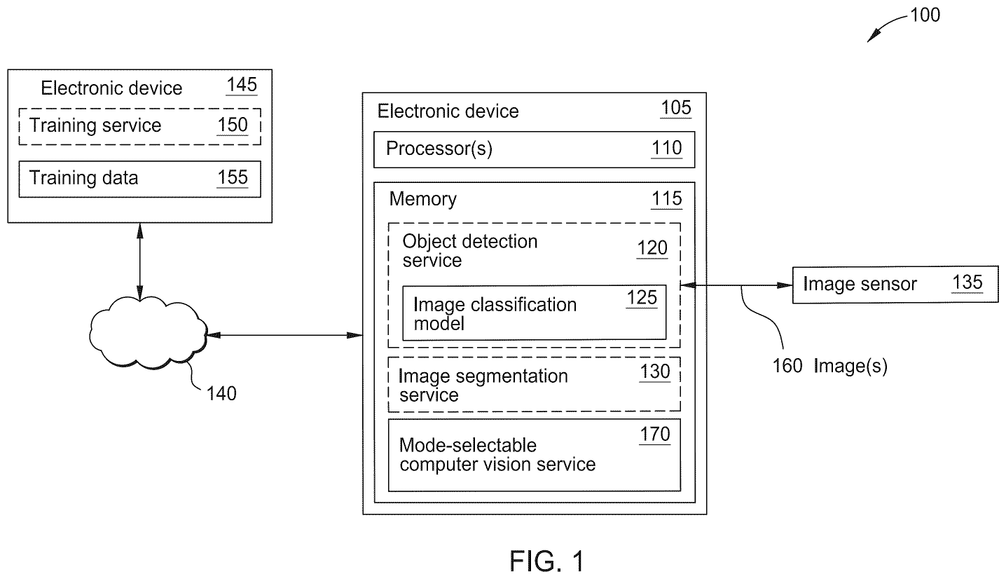

FIG. 1 depicts an example system 100 for mode-selectable computer vision using an image classification model, according to one or more aspects. The features of the system 100 may be used in conjunction with other aspects.

The system 100 comprises an electronic device 105 that is communicatively coupled with an image sensor 135. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth. Further, although described as being performed by a single electronic device, in other aspects, the functionalities of the system 100 may be performed by a plurality of electronic devices.

The electronic device 105 comprises one or more processors 110 and a memory 115. The one or more processors 110 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 115 and controls the operation of the system 100. The one or more processors 110 are not limited to a single processing device and may encompass multiple processing devices.

The one or more processors 110 may include other hardware that operates software to control and process information. In some aspects, the one or more processors 110 execute software stored in the memory 115 to perform any of the functions described herein. The one or more processors 110 control the operation and administration of the electronic device 105 by processing information (e.g., information received from input devices and/or communicatively coupled electronic devices).

The memory 115 may store, either permanently or temporarily, data, operational software, or other information for the one or more processors 110. The memory 115 may include any one or a combination of volatile or non-volatile local or remote devices suitable for storing information. For example, the memory 115 may include random-access memory (RAM), read-only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 115, a disk, a CD, or a flash drive. In particular embodiments, the software may include an application executable by the one or more processors 110 to perform one or more of the functions described herein.

In this example, the memory 115 stores a mode-selectable computer vision service 170, and optionally an object detection service 120 and an image segmentation service 130. The mode-selectable computer vision service 170 receives one or more images 160 from the image sensor 135 and performs a selected computer vision operation on the image(s) 160. In some aspects, the mode-selectable computer vision service 170 performs one of image classification, object detection, and image segmentation operations on the image(s) 160. In some aspects, the image(s) 160 include whole-image labels identifying the object(s) depicted therein. In other aspects, the image(s) 160 include label(s) with higher fidelity, such as label(s) associated with bounding boxes defined around objects, and label(s) applied to each pixel.

In general terms, the mode-selectable computer vision service 170 performs its computer vision operations by substituting portions of the image(s) 160 with reference pixels, and applying an image classification model 125 to the images having the substituted reference pixels. The image classification model 125 is trained to disregard the reference pixels (e.g., to classify portions of received images having the reference pixels as being non-relevant).

The reference pixels may have any suitable implementation that can be distinguished from the content of the image(s) 160 by the image classification model 125. In some aspects, the reference pixels are a single masking color (e.g., white). In other aspects, the reference pixels are a masking pattern (comprising pixels of multiple colors). The masking color or masking pattern may be predefined, or may be based on the content of the image(s) 160. For example, a color not expected to appear in the images may be selected (e.g., a neon color for images of a natural environment).

In some aspects, based on the particular computer vision operation that is selected by the mode-selectable computer vision service 170, a proportion of the image that is to be substituted with reference pixels may change. For example, a first proportion value (e.g., zero) may be applied when performing an image classification operation, a second proportion value greater than the first proportion value (e.g., 25%) may be applied when performing an object detection operation, and a third proportion value greater than the second proportion value (e.g., 50%) may be applied when performing an image segmentation operation.

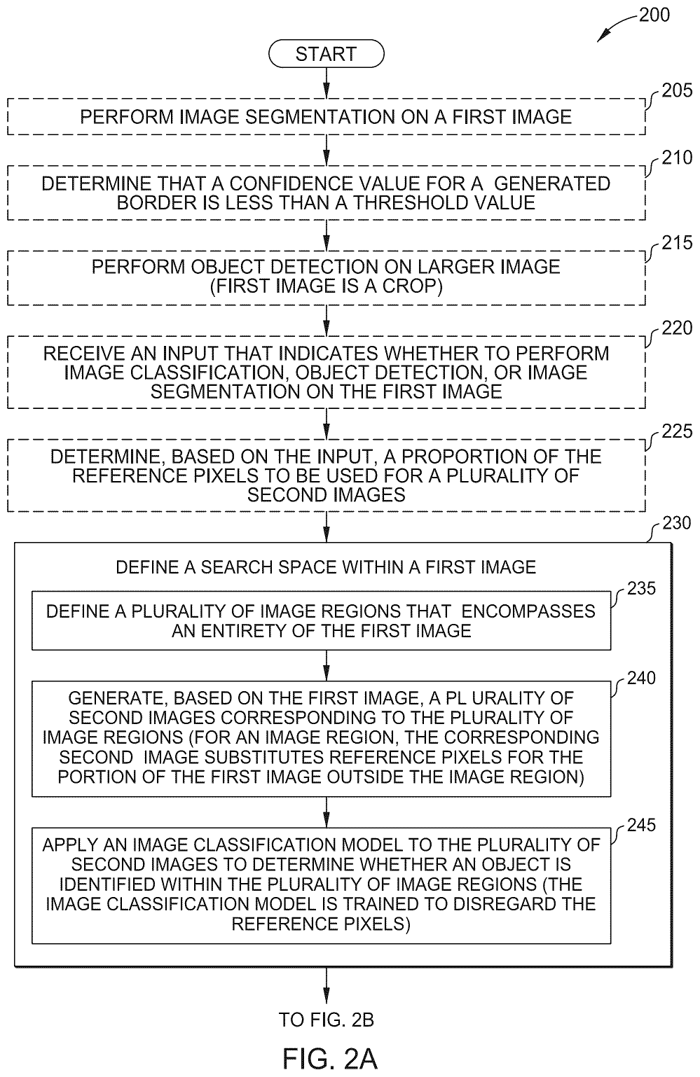

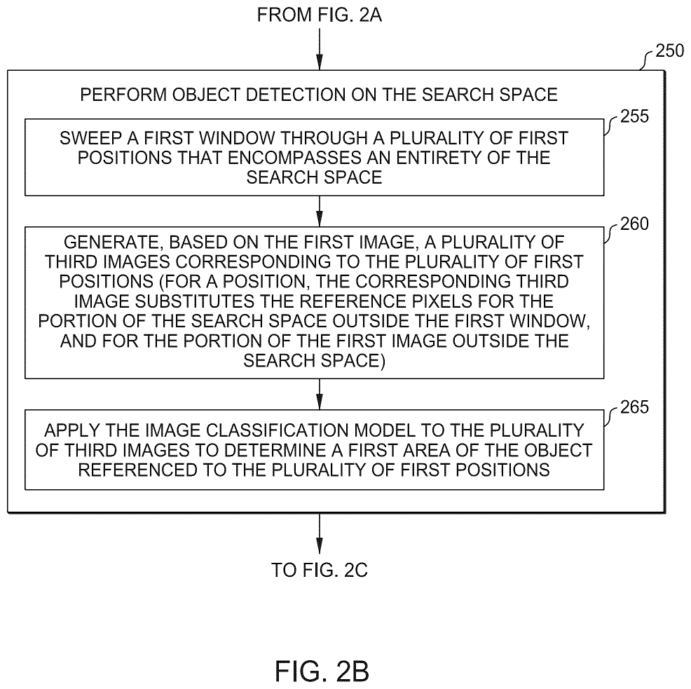

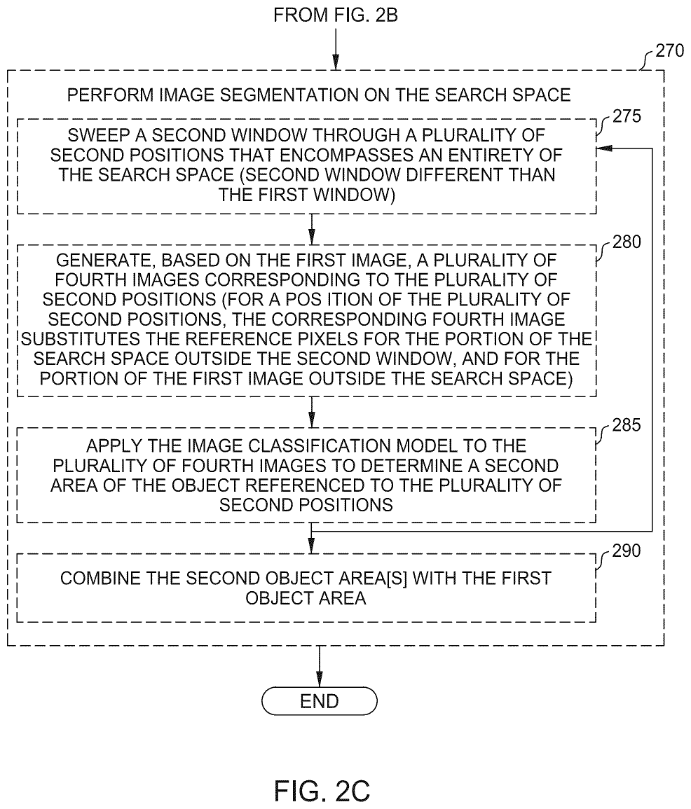

In some aspects, the values of the one or more parameters are based on one or more inputs received from a user. In one example, the input(s) may explicitly specify the values of the one or more parameters (e.g., 50% substitution, 25% substitution, one-pixel width stripe, and so forth). In another example, the input(s) may specify the computer vision operation, and the mode-selectable computer vision service 170 applies one or more predefined values depending on the specified operation. In yet another example, the input(s) may instruct the mode-selectable computer vision service 170 to perform the operation with the highest-possible fidelity. Additional details of the operation of the mode-selectable computer vision service 170 are discussed below with respect to FIG. 2.

As discussed above, the mode-selectable computer vision service 170 may be applied to the image(s) 160 independently, or in conjunction with other computer vision techniques. In some aspects, the mode-selectable computer vision service 170 is applied to the image(s) 160 as one layer of the object detection service 120.

The object detection service 120 receives the one or more images 160 from the image sensor 135, and identifies and classifies one or more objects depicted within the one or more images 160. The image sensor 135 may have any suitable implementation, such as a visible light sensor (e.g., an RGB camera) or an infrared (IR) light sensor. Other aspects of the image sensor 135 may use non-destructive inspection techniques to generate the one or more images 160, such as shearography. The one or more images 160 may be provided in any suitable format, such as individual images or a sequence of images (e.g., video). In some aspects, the one or more images 160 need not be supplied by the image sensor 135, and may include artificially-generated images, machine-produced output images, and so forth.

The object detection service 120 may be implemented with any suitable architecture, such as Faster R-CNN, Single-Shot MultiBox Detector (SSD), and You Only Look Once (YOLO). In some aspects, the object detection service 120 implements an object detection algorithm that includes the image classification model 125 (e.g., extractable), which may be adapted by the image segmentation service 130 and/or the mode-selectable computer vision service 170 to perform other computer vision operations (e.g., image classification, object detection, image segmentation) according to various techniques herein. In alternate aspects, the image classification model 125 may be implemented independent of the object detection service 120 and the object detection service 120 may be omitted.

In some aspects, the object detection algorithm implemented by the object detection service 120 is Hierarchical Models for Anomaly Detection (HMAD). In general terms, HMAD is an object detection algorithm that breaks an image into one or more crops at varying resolutions. Information from analysis of the one or more crops is combined to provide a better classification of the image and/or the one or more crops. In some aspects, the image segmentation service 130 is compatible with a lowest-level model of HMAD. Here, the “lowest-level model” represents a scenario in which the image(s) 160 are heavily subdivided into a plurality of crops in a grid pattern such that no pixels of the image(s) 160 are compressed or combined. Each of the plurality of crops is fed to the neural network of the image classification model 125 for classification. In some aspects, the plurality of crops are provided to mode-selectable computer vision service 170 to perform image classification and/or object detection operations on the crops. The classifications of the plurality of crops provides locations of any objects depicted in the image(s) 160 (e.g., the object detection function).

In one aspect, HMAD comprises: training a computational model to identify anomalous portions of a test component using training images and labels that indicate anomalous portions of training components within the training images; compressing a source image of the test component to generate a first input image having a first resolution; making a first determination, via the computational model, of whether the first input image indicates that the test component is anomalous; making a second determination, via the computational model and for each section of a plurality of sections of a second input image, of whether the section indicates that the test component is anomalous, wherein the second input image has a second resolution that is greater than the first resolution; providing, via a user interface, a first indication of whether the first input image indicates that the test component is anomalous; and providing, via the user interface, a second indication of whether the second input image indicates that the test component is anomalous.

The object detection service 120 may perform a number of different operations using the received one or more images 160. In some aspects, the object detection service 120 performs preprocessing of the one or more images 160 to enhance features, reduce noise, and/or standardize the input for the detection model. For example, the object detection service 120 may perform one or more of resizing, normalization, and color space conversion of the one or more images 160.

In some aspects, the object detection service 120 generates a plurality of crops (or cells) from the one or more images 160. The crops may have any suitable sizing, e.g., 224×224 pixels. Further, the crops may have other non-square shapes, such as rectangular, hexagonal, octagonal, n-sided polygon, and so forth. In some aspects, the object detection service 120 systematically progresses across (e.g., sweeps across) an individual image of the one or more images 160 to generate a plurality of crops for the image. Other techniques for selecting regions to generate a plurality of crops are also contemplated. The crops may or may not be partially overlapping with each other. In some aspects, the object detection service 120 may perform multiple passes of an individual image to generate pluralities of crops of different sizes.

In some aspects, the object detection service 120 comprises one or more feature extractors, which may employ a corresponding one or more Convolutional Neural Networks (CNNs). The CNN(s) learn hierarchical representations of an input image (e.g., a crop or the entire image), capturing features of the input image at different levels of abstraction. Deeper layers of the CNN tend to capture high-level semantic features, while shallower layers of the CNN tend to capture low-level features like edges and textures. Other architectures of the feature extractor(s) are also contemplated, such as neural networks using self-attention layers, capsule networks, dynamic convolutional networks, transformer networks, and spatial transformer networks.

In some aspects, the object detection service 120 comprises a Region Proposal Network (RPN) that proposes candidate regions in the image that are likely to depict objects. The object detection service 120 may further perform Region of Interest (Rol) pooling to transform the candidate regions into fixed-size feature vectors (or “feature maps”), enabling the object detection service 120 to process candidate regions that have different sizes and/or shapes.

In some other cases, the image segmentation service 130 is applied to the image(s) 160 before the mode-selectable computer vision service 170 is applied to the image(s) 160. In some aspects, the mode-selectable computer vision service 170 is applied to the image(s) 160 responsive to determining that a confidence value for a generated border by the image segmentation service 130 is less than a threshold value. This may be the case where multiple objects of interest are depicted within the image(s) 160 in close proximity, as the interstitial spaces may be incorrectly labeled.

In some aspects, the image classification model 125 comprises a classifier that determines the class of the object depicted within the candidate region. The classifier may have any suitable implementation, e.g., a neural network comprising a plurality of fully-connected layers and a softmax classification layer, a decision tree classifier, a support vector machine, a Bayesian network, or an ensemble model. Other aspects of the classifier are also contemplated, e.g., other types of feedforward neural networks. In some aspects, the image classification model 125 further comprises a regressor that refines the bounding box coordinates to precisely localize the object. In some aspects, the object detection service 120 applies Non-Maximum Suppression (NMS) to suppress redundant detections (e.g., overlapping bounding boxes) and/or low-confidence detections.

In some aspects, the object detection service 120 performs one or more post-processing operations, such as converting the bounding boxes and class probabilities into different formats. For example, the object detection service 120 may filter out those object detections that are below a predefined confidence threshold, and/or map class indices to human-readable labels.

In some aspects, the object detection service 120 performs the training of the feature extractor(s) and/or the image classification model 125, e.g., using a set of training data 155. The training data 155 is generally provided with a similar form as the operational data, e.g., (portions of) a plurality of images. As shown, the training data 155 is stored on an electronic device 145 that is separate from the electronic device 105. In some aspects, the electronic device 105 and the electronic device 145 are communicatively coupled through a network 140 (e.g., one or more local area networks (LANs) and/or a wide area network (WAN)). In other aspects, the training data 155 is stored in the memory 115 of the electronic device 105. In some aspects, the image classification model 125 is trained separately from the object detection service 120 and later incorporated thereinto.

In other aspects, the electronic device 145 comprises a training service 150 that performs the training of the feature extractor(s) using the training data 155. Once trained, the parameters (e.g., model weights) of the feature extractor(s) may be frozen. In some aspects, the pretrained fixed parameters of the feature extractor(s) are provided to the object detection service 120. The object detection service 120 performs the training of the image classification model 125 using the pretrained fixed parameters. For example, self-supervised pre-training can be done with the training data 155 without the image classification model 125. Then, a supervised fine-tuning is performed with some or all of the training data 155, but with the training done with the image classification model 125 in the loop against the labeled version of the training data 155.

FIGS. 2A-2C is an example method 200 of mode-selectable computer vision using an image classification model, according to one or more aspects. The method 200 may be used in conjunction with other aspects. For example, the method 200 may be performed by the mode-selectable computer vision service 170, and in some cases with the object detection service 120 and/or the image segmentation service 130.

The method 200 begins at an optional block 205, where the image segmentation service 130 performs image segmentation on a first image. At an optional block 210, the image segmentation service 130 determines that a confidence value for a generated border is less than a threshold value, which may indicate that multiple objects of interest are depicted in close proximity to each other in the first image.

At an optional block 215, the object detection service 120 performs object detection on a larger image, such that the first image represents a crop of the larger image.

At an optional block 220, the mode-selectable computer vision service 170 receives an input that indicates whether to perform image classification, object detection, or image segmentation on the first image. The input may be provided by a user or may be received from the image segmentation service 130 or the object detection service 120. At an optional block 225, the mode-selectable computer vision service 170 determines, based on the input, a proportion of the reference pixels to be used for a plurality of second images. Each of the second images includes a first portion comprising respective pixels from the first image, as well as a second portion in which reference pixels are substituted for the respective pixels from the first image. The plurality of second images are used to define a search space within the first image.

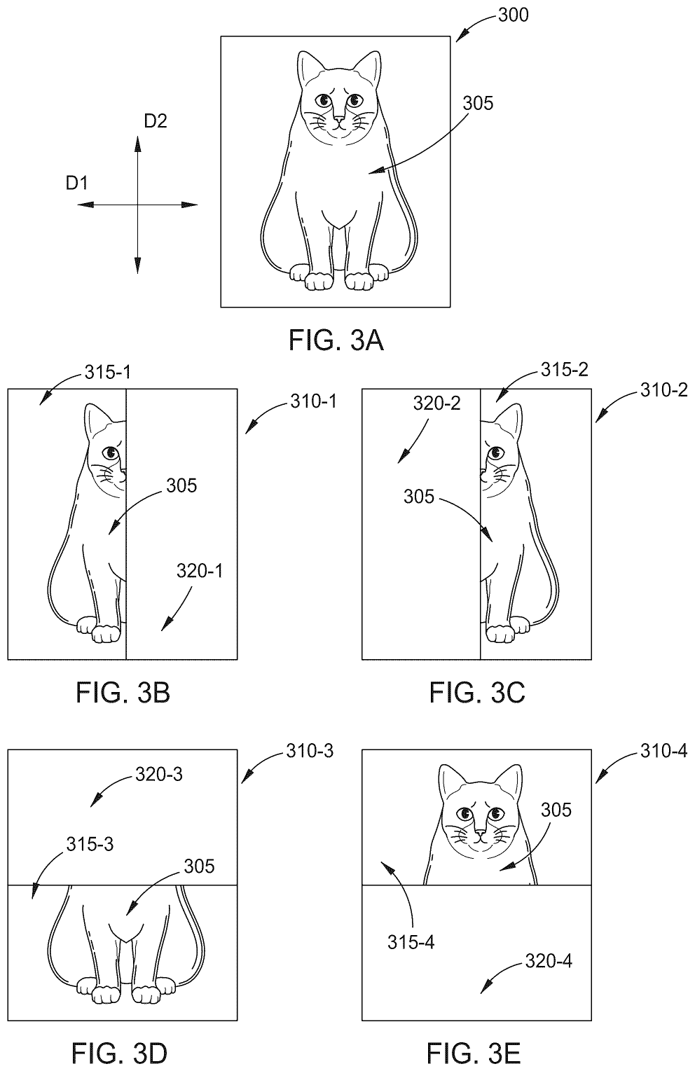

At block 230, the mode-selectable computer vision service 170 defines a search space within the first image. In some aspects, defining the search space comprises, at block 235, defining a plurality of image regions that encompasses an entirety of the first image. Referring now to FIGS. 3A-3E, a first image 300 depicts a cat 305 in the foreground. In some aspects, defining the search space comprises defining a plurality of first image regions, along a first dimension, that encompasses the entirety of the first image 300, and defining a plurality of second image regions, along a second dimension, that encompasses the entirety of the first image 300. In the examples shown in FIGS. 3B, 3C, two image regions are defined in a first dimension D1 (e.g., a horizontal axis), and in FIGS. 3D, 3E, two image regions are defined a second dimension D2 (e.g., a vertical axis) that is orthogonal to the first dimension D1.

While two dimensions and two image regions are described for simplicity, any other numbers of dimensions and image regions are also contemplated (e.g., one, three, four or more dimensions; three, four, five or more image regions). Further, the number of image regions need not be the same for the different dimensions. Still further, the dimensions need not be linear (e.g., along a curve, radial coordinates, etc.). Still further, the image regions may be dynamically determined based on prior results, a type of the image, contents of the image, and so forth.

The image regions along a particular dimension are shown as being non-overlapping with each other, and together are coextensive with the entirety of the first image 300. However, other aspects may have image regions that are partially overlapping with each other, and/or that extend beyond the entirety of the first image 300.

In some aspects, defining the search space further comprises, at block 240, generating, based on the first image, a plurality of second images corresponding to the plurality of image regions. For an image region, the corresponding second image substitutes reference pixels for the portion of the first image outside the image region. One example of generating the plurality of second images is depicted in FIGS. 3B-3E below.

FIGS. 3B, 3C depict two second images 310-1, 310-2 corresponding to image regions defined along the first dimension D1. The second image 310-1 is depicted having a left half comprising a left half 315-1 of the first image 300, and a right half comprising reference pixels 320-1 (here, white pixels). The second image 310-2 is depicted having a left half comprising reference pixels 320-2, and a right half comprising the right half 315-2 of the first image 300.

FIGS. 3D, 3E depict two second images 310-3, 310-4 corresponding to image regions defined along the second dimension D2. The second image 310-3 is depicted having an upper half comprising reference pixels 320-3, and a lower half comprising a lower half 315-3 of the first image 300. The second image 310-4 is depicted having an upper half comprising an upper half 315-4 of the first image 300, and a lower half comprising reference pixels 320-4.

In some aspects, defining the search space further comprises, at block 245, applying the image classification model 125 to the plurality of second images 310-1, 310-2, 310-3, 310-4 to determine whether an object is identified within the plurality of image regions. As mentioned above, the image classification model 125 can be trained to disregard the reference pixels 320-1, 320-2, 320-3, 320-4. Applying the image classification model 125 may return a discrete result whether the object is identified (e.g., a binary result or a matching classification), and may further return a confidence value for the classification.

In some aspects, defining the search space comprises applying a function to the plurality of image regions, such as an intersection function, a union function, a voting function, and so forth. Considering the example depicted in FIGS. 3A-3E, it is likely that the image classification model 125 would identify the cat 305 within each of the image regions (e.g., the left half 315-1, the right half 315-2, the lower half 315-3, and the upper half 315-4). As such, either the intersection function or the union function applied to the plurality of image regions would yield the entire first image 300.

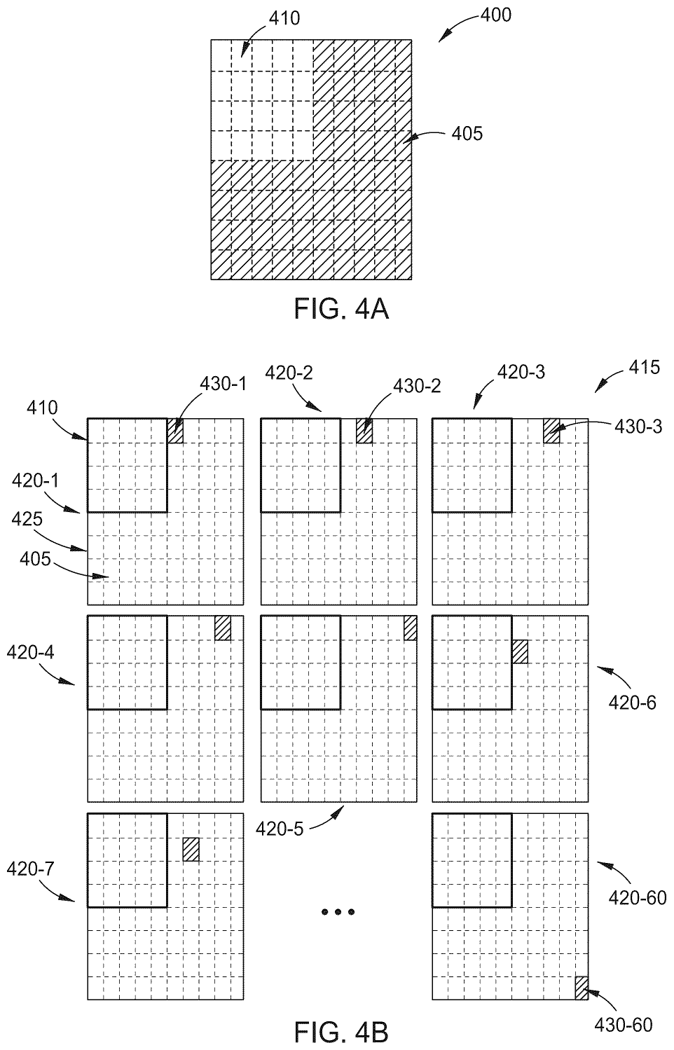

However, other aspects may define a search space that is less than the entirety of the first image 300. Defining a smaller search space is less time and resource-intensive in later stages where the search space is searched at a higher resolution. FIG. 4A depicts an example of defining a search space 405 within an image, according to one or more aspects.

Using the same plurality of image regions as those used in FIGS. 3A-3E (e.g., left half, right half, lower half, and upper half), in one example, assume that the image classification model 125 identifies an object in the right half and the lower half of an image, and does not identify the object in the left half and the upper half of the image. In this example, a union function is applied to the plurality of image regions to define the search space 405, as well as a portion 410 of the image that is excluded from the search space 405. In other examples, and depending on the sizes and locations of the plurality of image regions, the search space 405 need not be one contiguous area.

At block 250, the mode-selectable computer vision service 170 performs object detection on the search space 405 using the image classification model 125. In some aspects, the mode-selectable computer vision service 170 performs the object detection using the image classification model 125, without the need for training and/or employing separate models. In some aspects, performing object detection comprises, at block 255, sweeping a first window through a plurality of first positions that encompasses at least a portion of the search space 405. In some aspects, the plurality of first positions encompass an entirety of the search space 405. Diagram 415 of FIG. 4B depicts an example sequence of sweeping a window through a search space, according to one or more aspects. As shown, a rectangular grid 425 is overlaid on the entire image (including both the search space 405 and the excluded portion 410). The rectangular grid 425 defines a plurality of first positions 430-1, 430-2, 430-3, . . . , 430-60 that encompass the entirety of the search space 405. The plurality of first positions 430-1, 430-2, 430-3, . . . , 430-60 are shown as being non-overlapping with each other, and together are coextensive with the entirety of the search space 405. However, in other aspects, the plurality of first positions 430-1, 430-2, 430-3, . . . , 430-60 may partially overlap with each other, and may extend beyond the entirety of the search space 405. Further, arrangements of the plurality of the first positions 430-1, 430-2, 430-3, . . . , 430-60 other than the rectangular grid 425 are also contemplated (non-rectangular grids, staggered grids, and so forth).

As shown, the window is swept through the search space 405 sequentially through the plurality of first positions 430-1, 430-2, 430-3, . . . , 430-60, from left to right, and from top to bottom. Other possibilities of sweeping the window through the search space 405 are also contemplated, such as along different directions, different orders of the directions, non-sequential orders, random sequences, and so forth.

In some aspects, performing object detection further comprises, at block 260, generating, based on the first image, a plurality of third images corresponding to the plurality of first positions. The diagram 415 depicts a plurality of third images 420-1, 420-2, 420-3, . . . , 420-60 that correspond to the plurality of first positions 430-1, 430-2, 430-3, . . . , 430-60 of the window. For each first position 430-1, 430-2, 430-3, . . . , 430-60, the corresponding third image 420-1, 420-2, 420-3, . . . , 420-60 substitutes the reference pixels for the portion of the search space 405 outside the first position, and for the portion of the image outside the search space 405 (e.g., the excluded portion 410). In this way, each third image 420-1, 420-2, 420-3, . . . , 420-60 includes pixels from the first image only at the corresponding first position 430-1, 430-2, 430-3, . . . , 430-60 of the window.

In some aspects, the mode-selectable computer vision service 170 generates the plurality of third images 420-1, 420-2, 420-3, . . . , 420-60 directly from the first image (e.g., substituting the reference pixels for the portion of the search space 405 outside the first position, and for the portion of the image outside the search space 405). However, in other aspects, the mode-selectable computer vision service 170 generates the plurality of third images 420-1, 420-2, 420-3, . . . , 420-60 from one or more of the second images (e.g., the second images 310-1, 310-2, 310-3, 310-4) that are based on the first image. In this way, fewer pixel substitution operations need to be performed when generating the plurality of third images 420-1, 420-2, 420-3, . . . , 420-60, which is less time and resource-intensive.

In some aspects, performing object detection further comprises, at block 265, applying the image classification model 125 to the plurality of third images 420-1, 420-2, 420-3, . . . , 420-60 to determine a first area of the object referenced to the plurality of first positions 430-1, 430-2, 430-3, . . . , 430-60.

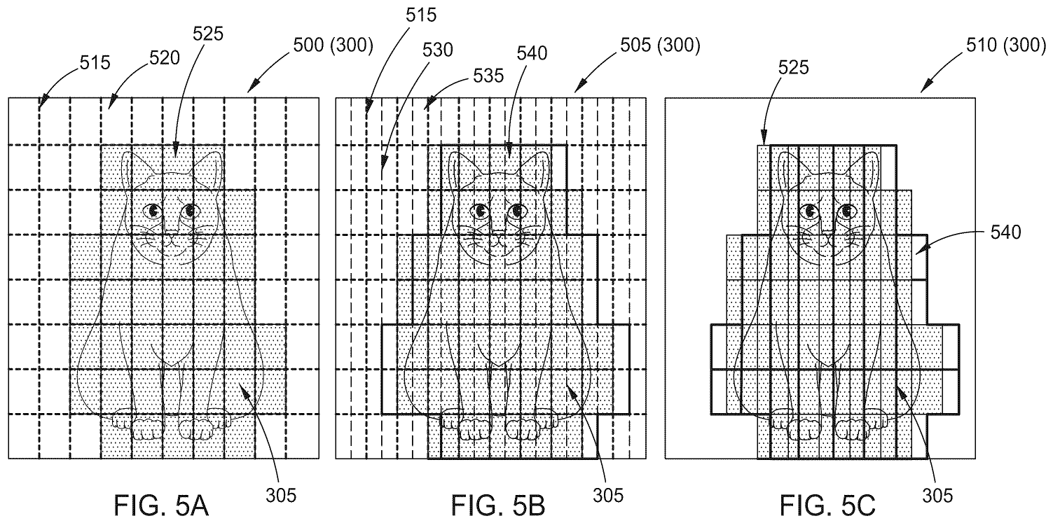

At an optional block 270, the mode-selectable computer vision service 170 performs image segmentation on the search space using the image classification model 125. In some aspects, the mode-selectable computer vision service 170 performs the image segmentation using the image classification model 125, without the need for training and/or employing separate models. FIGS. 5A-5C depict an example sequence of performing image segmentation on a search space, according to one or more aspects. The sequence may be used in conjunction with other aspects; for example, the diagram 500 of FIG. 5A in some cases depicts the first area of the object as determined at block 265.

In some aspects, performing image segmentation comprises, at an optional block 275, sweeping a second window through a plurality of second positions that encompasses at least a portion (e.g., an entirety) of the search space. The second window is different than the first window. In some aspects, the position of the second window is shifted from the position of the first window (e.g., a quarter-width shift or half-width shift in a particular direction along one of the dimensions D1, D2, or along another dimension). In some aspects, the second window may have a different size and/or a different shape than the first window, which may be in addition to or alternative to shifting the second window.

Diagram 500 depicts the image 300 with a rectangular grid 515 overlaid thereon. The rectangular grid 515 defines a plurality of first positions 520 of the first window. Assume for purposes of this example that the search space is determined to include the entirety of the image 300 (e.g., indicated that the cat 305 was detected in all image regions). In some aspects, an object detection operation (such as block 250) defines the first object area 525 of the object (e.g., the cat 305). In other aspects, a previous iteration of an image segmentation operation (e.g., ISOD performed as part of block 205) defines the first object area 525 of the object.

In some aspects, performing image segmentation further comprises, at an optional block 280, generating, based on the first image, a plurality of fourth images corresponding to the plurality of second positions. Diagram 505 depicts the image 300 with the rectangular grid 515 and a rectangular grid 530 overlaid thereon. The rectangular grid 530 has a same sizing as the rectangular grid 515, and is shifted a quarter-width to the right. The rectangular grid 530 defines a plurality of second positions 535 of the second window.

In some aspects, for each second position 535 of the second window, the corresponding fourth image substitutes the reference pixels for the portion of the search space outside the second window, and for the portion of the first image 300 outside the search space. In some aspects, performing image segmentation further comprises, at an optional block 285, applying the image classification model 125 to the plurality of fourth images to determine a second area 540 of the object (e.g., the cat 305) that is referenced to the plurality of second positions 535.

In some aspects, method 200 returns from block 285 to block 275 to perform one or more additional iterations within the image segmentation operation, in which the second window is different than previous iterations of the second window. Each additional iteration generates another second area of the object. In one non-limiting example, a respective plurality of fourth images is generated for each of a quarter-width shift to the right (0°), to the left (180°), up (90°), down (270°), in a “northeast” direction (45°), in a “northwest” direction (135°), in a “southwest” direction (225°), and in a “southeast” direction (315°). Other combinations of generating the pluralities of fourth images are also contemplated.

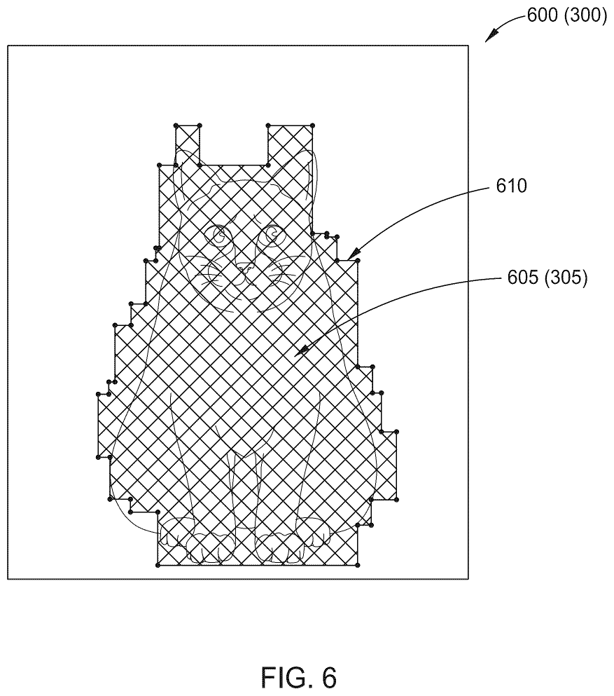

In some aspects, performing image segmentation further comprises, at an optional block 290, combining the second object area(s) 540 with the first object area 525. The overlap of the second object area 540 and the first object area 525 is depicted in diagram 510 of FIG. 5C. In some aspects, combining the second object area 540 with the first object area 525 comprises performing one of: an intersection function, a union function, and a voting function. Diagram 600 of FIG. 6 illustrates an example of a segmented object 605 that is generated by combining the second object area(s) 540 with the first object area 525 and applying an intersection function. The segmented object 605 generally appears as a contiguous polygon that is bounded by a border 610. The method 200 ends following completion of the block 250, or the optional block 270.

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method comprising:
defining a search space within a first image, which comprises:
defining a plurality of image regions that encompasses an entirety of the first image;
generating, based on the first image, a plurality of second images corresponding to the plurality of image regions, wherein for an image region of the plurality of image regions, the corresponding second image substitutes reference pixels for the portion of the first image outside the image region; and
applying an image classification model to the plurality of second images to determine whether an object is identified within the plurality of image regions, wherein the image classification model is trained to disregard the reference pixels; and
performing object detection on the search space using the image classification model.

2. The method of claim 1, wherein performing object detection on the search space comprises:
sweeping a first window through a plurality of first positions that encompasses an entirety of the search space;
generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and
applying the image classification model to the plurality of third images to determine a first area of the object referenced to the plurality of first positions.

3. The method of claim 2, further comprising:
performing image segmentation on the search space, wherein performing image segmentation comprises at least one iteration of:
sweeping a second window through a plurality of second positions that encompasses an entirety of the search space, the second window different than the first window;
generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space;
applying the image classification model to the plurality of fourth images to determine a second area of the object referenced to the plurality of second positions; and
combining the second area with the first area.

4. The method of claim 3, wherein combining the second area with the first area comprises performing one of: an intersection function; a union function; and a voting function.

5. The method of claim 1, wherein defining a plurality of image regions comprises:
defining a plurality of first image regions, along a first dimension, that encompasses at least a portion of the first image; and
defining a plurality of second image regions, along a second dimension, that encompasses at least a portion of the first image.

6. The method of claim 1, wherein the first image includes a whole-image label identifying the object.

7. The method of claim 1, further comprising:
receiving an input that indicates whether to perform image classification, object detection, or image segmentation on the first image; and
determining, based on the input, a proportion of the reference pixels to be used for generating the plurality of second images.

8. A computer program product comprising:
a computer-readable storage medium having computer-readable program code embodied therewith, the computer-readable program code executable by one or more computer processors to perform an operation comprising:
defining a search space within a first image, which comprises:
defining a plurality of image regions that encompasses an entirety of the first image;
generating, based on the first image, a plurality of second images corresponding to the plurality of image regions, wherein for an image region of the plurality of image regions, the corresponding second image substitutes reference pixels for the portion of the first image outside the image region; and
applying an image classification model to the plurality of second images to determine whether an object is identified within the plurality of image regions, wherein the image classification model is trained to disregard the reference pixels; and
performing object detection on the search space using the image classification model.

9. The computer program product of claim 8, wherein performing object detection on the search space comprises:
sweeping a first window through a plurality of first positions that encompasses an entirety of the search space;
generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and
applying the image classification model to the plurality of third images to determine a first area of the object referenced to the plurality of first positions.

10. The computer program product of claim 9, the operation further comprising:
performing image segmentation on the search space, wherein performing image segmentation comprises at least one iteration of:
sweeping a second window through a plurality of second positions that encompasses an entirety of the search space, the second window different than the first window;
generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space;
applying the image classification model to the plurality of fourth images to determine a second area of the object referenced to the plurality of second positions; and
combining the second area with the first area.

11. The computer program product of claim 10, wherein combining the second area with the first area comprises performing one of: an intersection function; a union function; and a voting function.

12. The computer program product of claim 8, wherein defining a plurality of image regions comprises:
defining a plurality of first image regions, along a first dimension, that encompasses at least a portion of the first image; and
defining a plurality of second image regions, along a second dimension, that encompasses at least a portion of the first image.

13. The computer program product of claim 8, wherein the first image includes a whole-image label identifying the object.

14. The computer program product of claim 8, the operation further comprising:
receiving an input that indicates whether to perform image classification, object detection, or image segmentation on the first image; and
determining, based on the input, a proportion of the reference pixels to be used for generating the plurality of second images.

15. A system comprising:
a memory storing an image classification model that is trained to disregard reference pixels; and
one or more processors configured to perform an operation comprising:
defining a search space within a first image, which comprises:
defining a plurality of image regions that encompasses an entirety of the first image;
generating, based on the first image, a plurality of second images corresponding to the plurality of image regions, wherein for an image region of the plurality of image regions, the corresponding second image substitutes the reference pixels for the portion of the first image outside the image region; and
applying an image classification model to the plurality of second images to determine whether an object is identified within the plurality of image regions; and
performing object detection on the search space using the image classification model.

16. The system of claim 15, wherein performing object detection on the search space comprises:
sweeping a first window through a plurality of first positions that encompasses an entirety of the search space;
generating, based on the first image, a plurality of third images corresponding to the plurality of first positions, wherein for a position of the plurality of first positions, the corresponding third image substitutes the reference pixels for the portion of the search space outside the first window, and for the portion of the first image outside the search space; and
applying the image classification model to the plurality of third images to determine a first area of the object referenced to the plurality of first positions.

17. The system of claim 16, the operation further comprising:
performing image segmentation on the search space, wherein performing image segmentation comprises at least one iteration of:
sweeping a second window through a plurality of second positions that encompasses an entirety of the search space, the second window different than the first window;
generating, based on the first image, a plurality of fourth images corresponding to the plurality of second positions, wherein for a position of the plurality of second positions, the corresponding fourth image substitutes the reference pixels for the portion of the search space outside the second window, and for the portion of the first image outside the search space;
applying the image classification model to the plurality of fourth images to determine a second area of the object referenced to the plurality of second positions; and
combining the second area with the first area.

18. The system of claim 17, wherein combining the second area with the first area comprises performing one of: an intersection function; a union function; and a voting function.

19. The system of claim 15, wherein defining a plurality of image regions comprises:
defining a plurality of first image regions, along a first dimension, that encompasses at least a portion of the first image; and
defining a plurality of second image regions, along a second dimension, that encompasses at least a portion of the first image.

20. The system of claim 15, wherein the first image includes a whole-image label identifying the object.
